(19) United States
(12) Patent Application Publication
(10) Pub. No.: US 2025/0141609 A1
(43) Pub. Date: May 1, 2025

(54) METHOD FOR RECOGNIZING ERRORS IN A COMMUNICATION SYSTEM

(71) Applicant: Robert Bosch GmbH, Stuttgart (DE)

(72) Inventors: Samuel Schaefer, Lorch (DE); Christof Possienke, Stuttgart (DE); Aboubacar Diarra, Ditzingen (DE); Matthias Kraenzlein, Leonberg (DE); Michael-Juergen Hofmann, Korntal-Muenchingen (DE); Steffen Baudisch, Pleidelsheim (DE)

(21) Appl. No.: 18/915,699

(22) Filed: Oct. 15, 2024

(30) Foreign Application Priority Data
Oct. 27, 2023 (DE) 10 2023 210 682.5

(51) Int. Cl. H04L 1/24; H04L 1/1607; H04L 1/20

(52) U.S. Cl. CPC H04L 1/24; H04L 1/1607; H04L 1/203

(57) ABSTRACT

A method for recognizing errors in a communication system in the form of a LIN bus system. The method includes: initiating a transmission of at least one data packet by a primary appliance of the communication system to at least one secondary appliance of the communication system; receiving at least one status message from a transmitter-receiver of the communication system; evaluating the at least one received status message with regard to an error upon receipt of a response data packet in response to the at least one transmitted data packet; recognizing an error based on the evaluation.

### FIELD

The present invention relates to a method for recognizing errors in a communication system. Furthermore, the present invention relates to a communication system, a computer program, a device and a storage medium.

### BACKGROUND INFORMATION

Open loads can occur in communication systems such as LIN bus systems if a conductor within the bus system is interrupted. This has the result that data communication between the networked units may be impaired. Furthermore, short circuits to ground occur, for example, in vehicle bus systems if the data conductor or the supply line is unintentionally connected to the ground potential of the vehicle. This can lead to an impairment of data communication and possible damage to the control appliances involved. Short circuits to the supply voltage occur when the data conductor comes into direct contact with the supply voltage line. This can lead to an increase in the current flow in the network, which activates the integrated protective mechanisms and, in the worst case, can damage the control appliances.

Conventional solutions cannot recognize errors such as open loads or short circuits in LIN systems. This means that the primary appliance, i.e. the master of the LIN bus, has no event to which it could react. This leads to the primary appliance continuing to work in normal operation even though there is actually an error. This makes it very difficult to draw conclusions about the actual cause of an error.

### SUMMARY

The present invention includes a method, a communication system, a computer program, a device, and a computer-readable storage medium. Features of and details relating to the present invention can be found in the disclosure herein. Features and details which are described in connection with the method according to the present invention of course also apply in connection with the communication system, computer program, device and computer-readable storage medium according to the present invention, and respectively vice versa, so that, with respect to the disclosure, mutual reference is or can be made to the individual aspects of the present invention at all times.

The present invention includes, in particular, a method for recognizing errors in a communication system, wherein the communication system is preferably provided in the form of a LIN bus system. The communication system, i.e., in particular the LIN bus system, can be a bus system of a vehicle, e.g., integrated into the vehicle.

Local Interconnect Network, or LIN bus or only LIN for short, is a communication system that can be used for data exchange between appliances, such as control appliances in automotive applications. This can be a serial communication system, specifically for the networking of sensors and actuators. Typical application examples include networking within the door or seat of a vehicle.

The method according to and example embodiment of the present invention can comprise the following steps, which are preferably carried out repeatedly and/or successively:
initiating a transmission of at least one data packet, preferably a digital data packet, by a primary appliance, preferably a master unit, of the communication system to at least one secondary appliance, preferably a slave unit, in particular to a plurality of secondary devices, of the communication system,
receiving at least one status message from a transmitter-receiver, in particular a transceiver, of the communication system, preferably the primary appliance, wherein the status message is preferably received in digital form,
evaluating the at least one received status message with regard to an error upon receipt of a response data packet in response to the at least one transmitted data packet—in other words, an error that indicates a problem or an unexpected event upon receipt of the response data packet, wherein the response data packet is expected in response to the transmitted data packet—, wherein a status code of the status message preferably is evaluated for this purpose,
recognizing an error based on the evaluation, preferably by ascertaining the cause of an error.

The present invention can have an advantage that errors according to error categories such as “open load,” “short circuit to ground” or “short circuit to the supply voltage” can be reliably recognized. This makes it possible to provide an event to which the primary appliance can react in the event of an error. Based on the precise “pin-pointing” to the actual cause of an error, workshop diagnosis can also be facilitated and/or a targeted replacement reaction and error treatment can be effected in the vehicle.

According to an example embodiment of the present invention, the transmitter-receiver is in particular a transceiver, preferably a LIN transceiver, and can be responsible for the physical transmission and reception of signals on the bus, preferably the LIN bus. For this purpose, the transmitter-receiver can, for example, convert the digital data from the primary or secondary appliances into electrical signals in order to transmit them via the bus line and, conversely, also receive the signals and convert them into data.

According to an example embodiment of the present invention, it is also advantageous if a plurality of secondary appliances are provided, at which the transmission of the at least one data packet is initiated. In this case, it is advantageous if the status message is specific for an individual and/or for an origin identifier of the secondary appliances. The origin identifier comprises, for example, a unique identifier for the secondary appliances and/or an indication of which of the secondary appliances (e.g., for a current frame) a response data packet was expected from.

In addition, according to an example embodiment of the present invention, the method step of recognizing can further comprise: recognizing an error-causing secondary appliance of the plurality of secondary devices on the basis of the status message. The communication system comprises, e.g., up to 16 secondary appliances on the one primary appliance. The cause of an error can be ascertained, e.g., on the basis of the status message and in particular on the basis of an origin identifier, which comprises, for example, an indication of which of the secondary appliances received or was expected to receive a response. This makes it possible to differentiate whether no response data packets are being consistently received from all secondary appliances or only from individual secondary appliances of the communication system.

Preferably, within the scope of the present invention, it can be provided that the recognition further comprises: assigning the error to one of at least two or at least three error categories. The error categories can comprise at least one of the following:
a short-circuit error, during which transmission (e.g., of the response data packet) by at least one of the secondary appliances is prevented by the fact that a transmission line (bus line) of the communication system is connected to electrical ground, e.g. the ground of a vehicle,
an open load error, during which transmission (e.g., of the response data packet) by at least one of the secondary appliances is prevented by the fact that the transmission line of the communication system is interrupted,
an operating error in one of the secondary appliances.

This makes it possible to further differentiate the cause of an error.

In a further option of the present invention, it can be provided that the evaluation is carried out on the basis of a predefined system specification of the communication system, wherein the recognition further comprises:
recognizing the cause of an error on the basis of a comparison of the at least one received status message with the system specification.

The primary appliance, in particular also referred to as the LIN master, can use the status message as feedback from the transmitter-receiver for error diagnostics thanks to the system specification in conjunction with additional system knowledge. This makes it possible to deduce the cause of an error based on existing knowledge of the communication system.

According to an example embodiment of the present invention, it is also possible that during the evaluation, the at least one received status message is evaluated with regard to a failure to receive the response data packet. This means that it is also possible to recognize if reception or transmission is completely prevented by a secondary appliance.

Another subject matter of the present invention is a communication system, preferably in the form of a LIN bus system. According to an example embodiment of the present invention, the communication comprises:
a primary appliance,
at least one or more secondary appliance(s),
a device for recognizing errors in the communication system, wherein the device preferably is provided in the form of an electronic data processing device and/or a data processing system and/or a device according to the present invention.

According to an example embodiment of the present invention, the device, e.g., a data processing device or a data processing system, can further comprise:
an initiating means for initiating transmission of at least one data packet by the primary appliance to the at least one secondary appliance or to the plurality of secondary appliances,
a receiving means for receiving at least one status message from a transmitter-receiver of the communication system, preferably the primary appliance,
an evaluation means for evaluating the at least one received status message with regard to an error upon receipt of a response data packet in response to the at least one transmitted data packet, wherein preferably the response is expected from at least one of the secondary appliances,
a recognition means for recognizing an error based on the evaluation.

The communication system according to the present invention thus delivers the same advantages as have been described in detail with reference to a method according to the present invention. In addition, the communication system, and specifically the device in particular, can be designed to carry out a method according to the present invention. The individual means can, for example, be part of one or more computer programs.

Furthermore, according to an example embodiment of the present invention, it is optionally provided that the device and/or the transmitter-receiver are part of the primary appliance, wherein further transmitter-receivers of the at least one or more secondary appliances can be provided. Furthermore, the primary appliance can be provided as a commander (master unit) and the relevant secondary appliance as a responder (slave unit) of the communication system. This allows for reliable communication, e.g. in the vehicle between different vehicle components. The LIN can, e.g., comprise a single master unit as the primary appliance and a plurality of slave units as the secondary appliances for data exchange between control appliances and/or appliances in automotive applications. The LIN can be located in various vehicle components, including but not limited to the dashboard, center console and door modules, in order to allow for targeted communication between specific control appliances such as climate control, power windows and seat adjustment.

The present invention also relates to a computer program, in particular a computer program product, comprising commands which, when the computer program is executed by a computer, cause the computer to carry out the method according to the present invention. The computer program according to the present invention thus delivers the same advantages as have been described in detail with reference to a method according to the present invention.

The present invention also relates to a device for data processing that is configured to carry out the method according to the present invention. For example, a computer which executes the computer program according to the present invention can be provided as the device. The computer can have at least one processor for executing the computer program. A non-volatile data memory can also be provided, in which the computer program is stored and from which the computer program can be read by the processor for execution. The device can optionally also be designed as a distributed computer system.

The present invention can also relate to a computer-readable storage medium which comprises the computer program according to the present invention and/or commands which, when executed by a computer, cause the computer to carry out the method according to the present invention. The storage medium is formed, for example, as a data memory such as a hard drive and/or a non-volatile memory and/or a memory card. The storage medium can be integrated into the computer, for example.

Furthermore, the method according to the present invention can also be carried out as a computer-implemented method.

Further advantages, features, and details of the present invention can be found in the following description, in which exemplary embodiments of the present invention are described in detail with reference to the figures. The features mentioned herein can be essential to the present invention, individually or in any combination.

### BRIEF DESCRIPTION OF THE DRAWINGS

FIG. 1 shows a schematic visualization of a method, a device, a storage medium and a computer program according to exemplary embodiments of the present invention.

FIG. 2 shows a schematic representation of a communication system according to exemplary embodiments of the present invention.

FIG. 3 shows a further representation of a device according to exemplary embodiments of the present invention.

### DETAILED DESCRIPTION OF EXAMPLE EMBODIMENTS

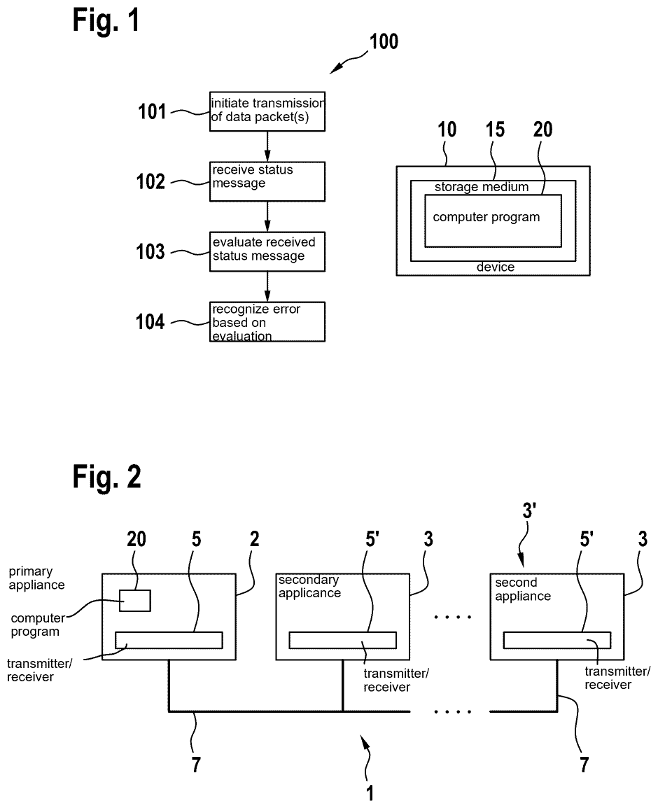

FIG. 1 schematically shows a method 100, a device 10, a storage medium 15, and a computer program 20 according to exemplary embodiments of the present invention. The method 100 can be provided for recognizing errors in a communication system 1 shown in FIG. 2 in the form of a LIN bus system. According to a first method step 101, initiating a transmission of at least one data packet can be effected by a primary appliance 2 of the communication system 1 to at least one secondary appliance 3 of the communication system 1. According to a second method step 102, receiving at least one status message from a transmitter-receiver can be provided. According to a third method step 103, evaluating the at least one received status message with regard to an error can be effected upon receipt of a response data packet in response to the at least one transmitted data packet. Then, according to a fourth method step 104, the error can be recognized based on the evaluation.

FIG. 2 shows that a plurality of secondary appliances 3 can also be provided at which the transmission of the at least one data packet is initiated. The status message can be specific for an individual and/or for an origin identifier of the secondary appliances 3. Based on the recognition 104, it may be possible that a secondary appliance 3′ of the secondary appliances 3 causing the error is ascertained on the basis of the status message.

The recognition 104 can further comprise assigning the error to one of at least two or at least three error categories. For example, this may be a short-circuit error, during which transmission by at least one of the secondary appliances 3 is prevented by the fact that a transmission line 7 of the communication system 1 is connected to electrical ground. In order to make this error assignment, the status message can be evaluated to the effect that the transmitter-receiver (transceiver) returns a “frame header error.” This can be effected, for example, in the event of a LIN short circuit to ground, during which all bits of the secondary appliance are set to zero (low level), as well as in the event of a LIN short circuit to supply voltage, during which all bits of the secondary appliance are set to one (high level). Based on the evaluation of this “frame header error,” the short-circuit error is thus diagnosed.

There may also be an error due to an open load, during which transmission by at least one of the secondary appliances 3 is prevented by the fact that the transmission line 7 of the communication system 1 is interrupted. The transmitter-receiver (transceiver) can provide a so-called “no response” state via the status message as soon as no response is received from the secondary appliance (or from the secondary appliances). This “no response” state can be used to diagnose an “open load” error.

With both of the aforementioned diagnostics, various system states can be taken into account before an error is reported. This includes, for example, the frequency recognition of the error state, among other things. During frequency recognition, a counter is incremented in particular each time the “no response” state occurs. Subsequently, the counter can be checked against an applicable threshold value. If this is exceeded, an “open load” error can be diagnosed and reported as a reaction. If a valid response from a secondary appliance is received in the primary appliance during the frequency check, there can be no “open load” error and the counter is thus reset to zero. In this way, a system specification and/or system knowledge can be used for evaluation and/or recognition.

The device 10 and/or the transmitter-receiver 5 can be part of the primary appliance 2, wherein further transmitter-receivers 5′ of the at least one or more secondary appliances 3 are optionally provided (see FIG. 2). It is possible that the communication system in the form of a LIN bus operates on a time-slot basis according to the question-answer principle (master-slave) by means of a schedule table (transmission scheme). A schedule table can refer to a predefined sequence of frames that controls the timing of communication between the primary appliance and the secondary appliances. This transmission scheme can specify when and in what order certain frames are sent via the LIN bus in order to ensure coordinated and efficient data exchange. The actual communication between master and slave is divided into two main components of the data packet and/or response data packet, the frame header and the user data.

In conjunction with a Local Interconnect Network (LIN), a data packet, also referred to as a frame, can comprise a frame header and the associated user data. The frame header contains information such as the identifier and the length of the frame. The user data carry the actual information load and can comprise control commands or measured values that are exchanged between the control appliances.

Unconditional frames are the data frames that are transmitted between the primary appliance and the secondary appliances according to a specified transmission scheme (schedule table). These frames can contain user data such as control commands or measured values and can be sent independently of certain conditions or events in the system. They can form the basis for regular and scheduled communication within the LIN bus system.

Traditionally, only the user data of the secondary appliances are processed. According to embodiments of the present invention, the frame header can also be evaluated based on the LIN transceiver feedback (i.e., the status message) and subsequently converted into error states.

According to a further embodiment of the present invention, the method cannot be based on so-called unconditional frames (i.e., standard data frames), but can send a special so-called event-triggered frame at certain intervals, which addresses all secondary appliances on the bus. This would allow all secondary appliances to be queried as “simultaneously” as possible and simplify the debounce method for recognizing errors. Since the primary appliance on a LIN bus can resolve possible collisions by definition by means of a special transmission scheme (collision resolving), the query of all secondary appliances is also guaranteed.

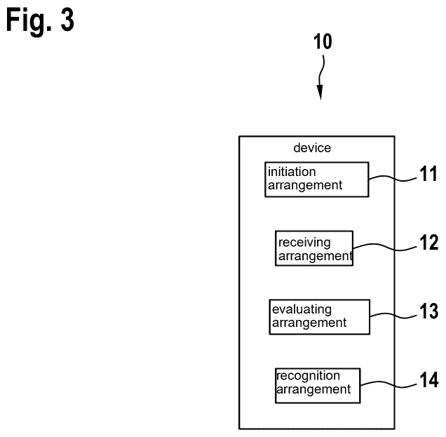

FIG. 3 shows a device 10 of a communication system 1 according to embodiments of the present invention with further details. An initiation means 11 can be provided for initiating 101 the transmission of the at least one data packet by the primary appliance 2 to the at least one secondary appliance 3. Furthermore, a receiving means 12 for receiving 102 the at least one status message of the transmitter-receiver of the communication system 1 and an evaluating means 13 for evaluating 103 the at least one received status message with regard to the error upon reception of the response data packet in response to the at least one transmitted data packet may be part of the device 10. A recognition means 14 can also be used to recognize 104 the error based on the evaluation.

The above description of the example embodiments describes the present invention exclusively in the context of examples. Of course, individual features of the embodiments, provided they make technical sense, can be freely combined with one another without departing from the scope of the present invention.

1-11. (canceled)

12. A method for recognizing errors in a communication system in the form of a LIN bus system, the method comprising the following steps:
initiating a transmission of at least one data packet by a primary appliance of the communication system to at least one secondary appliance of the communication system;
receiving at least one status message from a transmitter-receiver of the communication system;
evaluating the at least one received status message with regard to an error upon receipt of a response data packet in response to the at least one transmitted data packet;
recognizing an error based on the evaluation.

13. The method according to claim 12, wherein a plurality of secondary appliances are provided, at which the transmission of the at least one data packet is initiated, wherein the status message is specific for an individual and/or for an origin identifier of the secondary appliances, the recognition further including:
recognizing an error-causing secondary appliance of the secondary appliances based on the status message.

14. The method according to claim 13, wherein the recognition further includes:
assigning the error to one of at least two or at least three error categories, wherein the error categories include at least one of the following:
a short-circuit error, during which transmission by at least one of the secondary appliances is prevented by the fact that a transmission line of the communication system is connected to electrical ground,
an error due to an open load, during which transmission by at least one of the secondary appliances is prevented by the fact that the transmission line of the communication system is interrupted,
an operating error in one of the secondary appliances.

15. The method according to claim 12, wherein the evaluation is carried out based on a predefined system specification of the communication system, and wherein the recognition further includes:
recognizing a cause of an error based on a comparison of the status message with the system specification.

16. The method according to claim 12, wherein during the evaluation, the at least one received status message is evaluated with regard to a failure to receive the response data packet.

17. A communication system in the form of a LIN bus system, comprising:
a primary appliance;
at least one secondary appliance; and
a device configured to recognize errors in the communication system, wherein the device comprises:
an initiating arrangement configured to initiate a transmission of at least one data packet by the primary appliance to the at least one secondary appliance,
a receiving arrangement configured to receive at least one status message from a transmitter-receiver of the communication system,
an evaluation arrangement configured to evaluate the at least one received status message with regard to an error upon receipt of a response data packet in response to the at least one transmitted data packet, and
a recognition arrangement configured to recognize an error based on the evaluation.

18. The communication system according to claim 17, wherein the device and/or the transmitter-receiver is part of the primary appliance, wherein further transmitter-receivers of the at least one or more secondary appliances are provided, wherein the primary appliance is provided as a commander and the secondary appliance is provided as a responder of the communication system.

19. A device for data processing, the device configured to recognize errors in a communication system in the form of a LIN bus system, the device configured to:
initiate a transmission of at least one data packet by a primary appliance of the communication system to at least one secondary appliance of the communication system;
receive at least one status message from a transmitter-receiver of the communication system;
evaluate the at least one received status message with regard to an error upon receipt of a response data packet in response to the at least one transmitted data packet;
recognize an error based on the evaluation.

20. Anon-transitory computer-readable storage medium on which are stored commands for recognizing errors in a communication system in the form of a LIN bus system, the commands, when executed by a computer, causing the computer to perform the following steps:
initiating a transmission of at least one data packet by a primary appliance of the communication system to at least one secondary appliance of the communication system;
receiving at least one status message from a transmitter-receiver of the communication system;
evaluating the at least one received status message with regard to an error upon receipt of a response data packet in response to the at least one transmitted data packet;
recognizing an error based on the evaluation.
